(19) United States
(12) Patent Application Publication
(10) Pub. No.: US 2005/0266857 A1
(43) Pub. Date: Dec. 1, 2005

(54) Location based execution rights

(75) Inventor: Heikki Poikela, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/856,006

(22) Filed: May 27, 2004

(51) Int. Cl. H04Q 7/20

(52) U.S. Cl. 455/456.3; 455/456.1; 455/414.1

(57) ABSTRACT

A method, device, and system provide location-based execution rights for applications in mobile terminals. The method, for example, includes setting a key for location-based identification of a mobile terminal where the key corresponds to an application; upon executing the application, checking the key for a condition indicating that execution rights are available; ending the application if the condition indicates execution rights are not available; and continuing execution of the application if the condition indicates execution rights are available.

### FIELD OF THE INVENTION

The present invention relates to systems and methods for usage models for mobile terminals. More particularly, the present invention relates to location-based execution rights in mobile terminals.

### BACKGROUND OF THE INVENTION

Business and consumer users are enthusiastically embracing mobile devices such as cellular phones, personal digital assistants, and notebook computers, which let them access information almost as conveniently as if they were sitting at a desktop computer with a fixed network connection. Mobility also gives rise to a new application class, location-based services, that tailor applications and information on the basis of the user's geographical position. An example of a location-based service is a computer that provides the weather forecast for a current location.

Some known systems provide information to a mobile terminal based on its location. For example, U.S. Pat. No. 6,434,381 describes a wireless communication system that provides mobile terminals with local information and services custom-tailored to a predetermined area around the location where the mobile terminal is located. Another example is U.S. Pat. No. 6,131,028, which describes a wireless communication system which provides location-based call forwarding or directions to other locations.

While location-based services are known, such services have not been combined with application execution rights. That is, heretofore, systems have not associated the ability to run an application on a wireless device with the location where the mobile terminal is located. In one sense, it seems antithetical to the concept of wireless mobility to limit the ability to run applications to a location, but such a capability could be used by businesses to attract customers to a location, enhance the security of applications by only allowing an application to run in a location with controlled access, or other such implementations.

Thus, there is a need for a system utilizing location-based execution rights in mobile terminals. Further, there is a need to create business opportunities by limiting access to computer applications to a business locale. Even further, there is a need to utilize location-based execution rights to enhance security features on mobile terminals.

### SUMMARY OF THE INVENTION

The present invention is directed to location-based execution rights in mobile terminals. Briefly, one exemplary embodiment relates to a method of providing location-based execution rights for applications in mobile terminals. The method includes setting a key for location-based identification of a mobile terminal where the key corresponds to an application; and upon executing the application, checking the key for a condition indicating that execution rights are available.

Another exemplary embodiment relates to a device that executes at least one application based on location-based execution rights. The device includes a secure store including a location-based rule and a processor configured to, upon executing an application, determine if the location-based rule is satisfied and ceasing to run the application if the location-based rule is not satisfied at any time while the program runs.

Yet another exemplary embodiment relates to a system for providing location-based execution rights for applications in mobile terminals. The system includes an application programming interface (API) and a location-based key in a secure store for location-based identification of a mobile terminal where the key corresponds to an application, means for performing rule checking routines to determine if the location-based key is satisfied, and means for ceasing to run the application if the location-based key is not satisfied.

Another exemplary embodiment relates to a computer program product for providing location-based execution rights for applications in mobile terminals. The computer program product includes computer code to set a key for location-based identification of a mobile terminal, where the key corresponds to an application, and, upon executing the application, check the key for a condition indicating that execution rights are available.

Yet another exemplary embodiment relates to a server for verifying location-based execution rights for applications in mobile terminals. The server includes means for distributing a key for location-based identification of a mobile terminal, where the key corresponds to an application; and means for checking the key for a condition indicating that execution rights are available upon executing the application.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a flow diagram depicting operations performed in a system which includes location-based execution rights for mobile devices in accordance with an exemplary embodiment.

FIG. 2 is a diagram depicting a device having software operable only in a certain location in accordance with an exemplary embodiment.

FIG. 3 is a flow diagram depicting operations involved in a mobile communication system with location-based execution rights in accordance with an exemplary embodiment.

### DETAILED DESCRIPTION OF EXEMPLARY EMBODIMENTS

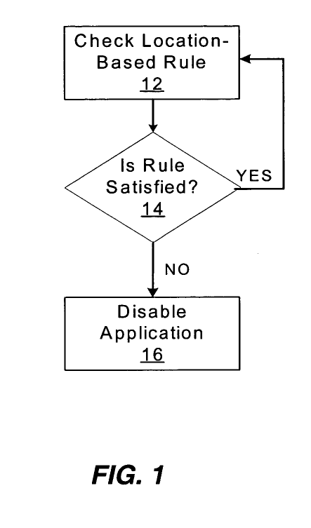

FIG. 1 illustrates a flow diagram depicting operations performed in a system which includes location-based execution rights for mobile devices. Additional, fewer, or different operations may be performed, depending on the embodiment. In an operation 12, a location-based rule stored in a mobile terminal is checked. The location-based rule can be, for example, a Bluetooth device connection, a landmark or geographical location, or a cell identifier from a cellular network. In an operation 14, a determination is made as to whether the location-based rule is satisfied. For example, the Bluetooth device connection rule is satisfied if the mobile terminal has a current connection to a Bluetooth device.

If the rule is not satisfied, the application is disabled or suspended in an operation 16. However, if the rule is satisfied, the application continues. In an exemplary embodiment, the location-based rule is checked periodically or at frequent intervals. For example, a customer of a coffee shop may have a laptop computer with an location-based execution rights application provided by the coffee shop. The application has a location-based rule such that it only operates when the customer is at the coffee shop. As a result, the application is functional as long as the device has a connection to a Bluetooth server located in the coffee shop.

In another exemplary embodiment, the location-based rule is utilized to enhance security features in an application where the user wants certain applications to only be functional in certain locations. For example, an application with personal financial data may be set to only function within the user's home. Another example is a company setting important applications to only operate within its facilities.

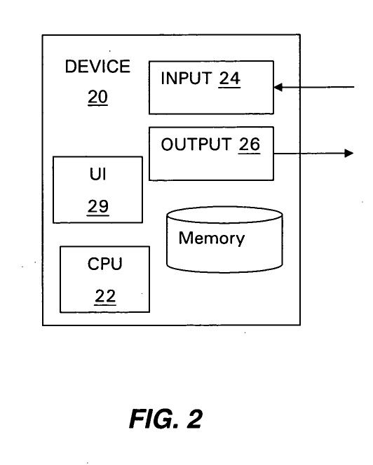

FIG. 2 illustrates a device 20 having a central processing unit (CPU) 22, an input 24, an output 26, a memory 28, and a user interface (UI) 29. The memory 28 can include the location-based rule described with reference to FIG. 1. The CPU 22 processes instructions related to checking the location-based rule and executing the application when the location-based rule is satisfied. The device 70 can be a phone, a personal digital assistant (PDA), a computer, or any other device.

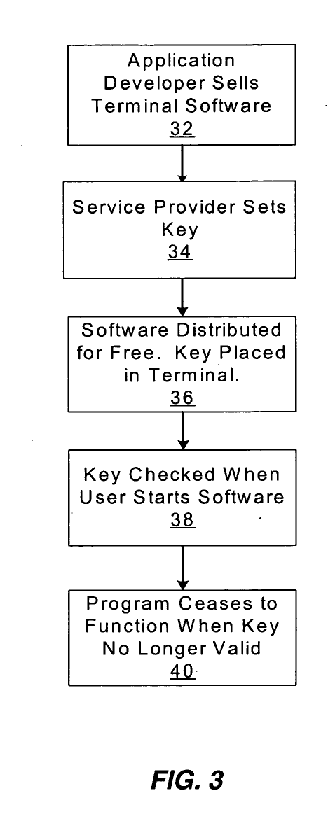

FIG. 3 illustrates a flow diagram depicting operations performed in a system which includes location-based execution rights for mobile devices. Additional, fewer, or different operations may be performed, depending on the embodiment.

In an operation 32, an application developer sells terminal software. The software can be sold directly to an end user or to a business. In an operation 34, a service provider can set a key for a location-based rule. For example, a Bluetooth device identifier can be the key used to identify if the software is on a specific device that is within range of an associated Bluetooth-enabled server.

In an operation 36, the software having the location-based rule is distributed free of charge to customers of a business whom the business wants to attract to a location. During installation of the software, the key having the location-based rule is placed in a secure store in the device.

In an operation 38, when the user starts the program, a check is made that the key condition is OK. For example, in the case of a Bluetooth connection rule, if the Bluetooth server can be found, the key condition is OK, and the application can run. In an operation 40, when the key condition is no longer valid, such as the user is no longer within range of the Bluetooth server, the application ceases to function.

This detailed description outlines exemplary embodiments of a method, device, and system for location-based execution rights in mobile terminals. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

1. A method of providing location-based execution rights for applications in mobile terminals, the method comprising:
setting a key for location-based identification of a mobile terminal, wherein the key corresponds to an application; and
upon executing the application, checking the key for a condition indicating that execution rights are available.

2. The method of claim 1, further comprising:
disabling the application if the condition indicates execution rights are not available; and
continuing execution of the application if the condition indicates execution rights are available.

3. The method of claim 1, further comprising locating the key in a secure store in the mobile terminal.

4. The method of claim 1, further comprising checking the key for a condition indicating that execution rights are available at frequent, non-periodic intervals during operation of the application.

5. The method of claim 1, wherein the condition is whether the mobile terminal is within coverage of a bluetooth server.

6. The method of claim 1, wherein setting a key for location-based identification of a mobile terminal is done by a service provider.

7. The method of claim 1, wherein the application is an application specific to a business location and the condition in which execution rights are available corresponds to the mobile terminal being within an area of the business location.

8. The method of claim 1, wherein the condition is whether the mobile terminal is a proximate distance to a geographical location.

9. The method of claim 1, wherein the condition is a cell identifier from a cellular network.

10. The method of claim 1, further comprising during continued execution of the application, checking the key for the condition and, if the condition indicates that execution rights are not available, disabling the application.

11. The method of claim 10, wherein the key is checked during periodic intervals.

12. The method of claim 10, wherein the execution of the disabled application is continued when the condition is again satisfied.

13. A device for executing at least one application based on location-based execution rights, the device comprising:
a store including a location-based rule; and
a processor configured to, upon executing an application, determine if the location-based rule is satisfied and disabling the application if the location-based rule is not satisfied while the program runs.

14. The device of claim 13, wherein the location-based rule is a connection to a Bluetooth device.

15. The device of claim 13, wherein the location-based rule is a landmark identified by a location system.

16. The device of claim 15, wherein the location system is a global positioning system (GPS).

17. The device of claim 13, wherein the location-based rule is a cell identifier from a cellular network.

18. A system for providing location-based execution rights for applications in mobile terminals, the system comprising:
an application programming interface (API); and
a location-based key in a secure store for location-based identification of a mobile terminal, wherein the key corresponds to an application,
wherein the API further performs rule checking routines to determine if the location-based key is satisfied and disables the application if the location-based key is not satisfied.

19. The system of claim 18, wherein they location-based key is associated with a freely-distributed game that only functions in a particular vicinity.

20. The system of claim 19, wherein the particular vicinity is a business location.

21. The system of claim 19, wherein the location-based key is a network connection.

22. The system of claim 18, wherein the location-based key is security condition that limits access of secure data to particular locations.

23. The system of claim 18, wherein an application developer uses the API to develop an application using location-based rights.

24. A computer program product for providing location-based execution rights for applications in mobile terminals, the computer program product comprising:
computer code to set a key for location-based identification of a mobile terminal, wherein the key corresponds to an application, and, upon executing the application, check the key for a condition indicating that execution rights are available.

25. The computer program product of claim 24, further comprising:
computer code to disable the application if the condition indicates execution rights are not available and continue execution of the application if the condition indicates execution rights are available.

26. The computer program product of claim 25, further comprising computer code to continue the execution of the disabled application if the condition indicates execution rights become available.

27. A server for verifying location-based execution rights for applications in mobile terminals, the server comprising:
means for distributing a key for location-based identification of a mobile terminal, wherein the key corresponds to an application; and
means for checking the key for a condition indicating that execution rights are available upon executing the application.

28. The server of claim 27, further comprising:
means for disabling the application if the condition indicates execution rights are not available; and
means for continuing execution of the application if the condition indicates execution rights are available.
